(19) United States
(12) Patent Application Publication
(10) Pub. No.: US 2007/0157769 A1
(43) Pub. Date: Jul. 12, 2007

(54) GAS METER VALVE TOOL

(75) Inventor: Michael E. NATOLI, Eureka, MO (US)

Correspondence Address: ZARLEY LAW FIRM P.L.C., CAPITAL SQUARE, 400 LOCUST, SUITE 200, DES MOINES, IA, 50309-2350, US

(73) Assignee: NATOLI ENGINEERING COMPANY, INC., St. Charles, MO (US)

(21) Appl. No.: 11/306,833

(22) Filed: Jan. 12, 2006

(51) Int. Cl. B25B 13/06

(52) U.S. Cl. 81/121.1

(57) ABSTRACT

A one piece tool for use with a gas meter valve having a movable core with a post for actuation of the core, the tool including a main body having a handle portion located at a distal end of the main body and a post aperture located at a proximal end of the main body. The post aperture is formed to completely enclose around the post of the gas meter valve. A proximal depression located at the proximal end of the main body provides a grip for a user adjacent the post aperture for fitting the post aperture over the post. A distal depression located at the distal end of the main body provides a grip for a user to actuate the gas meter valve. A loop aperture located at the distal end of the main body attaches the tool to a user or near the gas meter valve.

### BACKGROUND OF THE INVENTION

This invention pertains to tools for use with gas meters, and more particularly, tools for turning the gas supply to a gas meter on or off.

Natural gas is a common energy source, supplied through a gas line to a gas meter. A typical gas meter has an inlet line positioned to the left as one faces the meter, and an outlet line positioned to the right of the gas meter. Gas enters the meter from the main at the street through the inlet pipe and leaves the meter and enters the building piping through the outlet pipe. The valve used to turn the gas supply on and off is located on the inlet pipe.

With reference to FIGS. 1 and 2, a prior art gas meter includes a gas meter valve 10 inserted in a gas line 12 having a core 14 that forms a movable part of the valve 10 for opening and closing the gas line 12 allowing gas to flow. The core 14 may be rotated 360° in either direction. However, turning the core 14 from the “on” position to the “off” position requires only a quarter turn (or 90°) in either direction, whichever is easier.

As shown in FIG. 2, when an arm 16 attached to the core 14 is in alignment with the piping 12, the valve 10 is open. As seen in FIG. 1, when the arm 16 is perpendicular to the piping 12, the valve 10 is closed.

The arm 16 of the gas meter valve 10 is provided with a post 18 that extends upwardly from an outer end of arm 16. It is known in the art to use an adjustable tool for gripping the post 18 to close or open the gas meter valve 10. Such adjustable tools include adjustable wrenches (commonly referred to as a crescent wrench), pliers, channel-lock pliers (also known as water-pump pliers), pipe wrenches, monkey wrenches, vice grips, and other wrenches as long as they are the proper size and provide the leverage needed to turn the valve 10.

However, none of these adjustable tools are specifically designed for the task at hand. Specifically, all of the adjustable tools known in the art require multiple piece construction, with moving parts adjustable to accommodate the post 18. Accordingly, the adjustable tools known in the art are all more costly and complex than necessary for the particular task of closing gas meter valves 10.

Additionally, all of the adjustable tools known in the art have an opening at one end when associated with the post 18 of the gas meter valve 10. Accordingly, the adjustable tools known in the art do not form a complete enclosure around post 18, potentially forming a faulty grip on the post 18 and requiring additional manual force to both grip post 18 and turn arm 16.

Therefore an object of the present invention is to provide a gas meter valve tool of one piece construction devoid of any moving part.

A further object of the present invention is to provide a gas meter valve tool formed to completely enclose the post of the gas meter valve.

These and other objects will be apparent to those skilled in the art.

### SUMMARY OF THE INVENTION

A one piece tool for use with a gas meter valve having a movable core with a post for actuation of the core, the tool including a main body having a handle portion located at a distal end of the main body and a post aperture located at a proximal end of the main body. The post aperture is formed to completely receive and enclose the post of the gas meter valve to actuate the core. A proximal depression located at the proximal end of the main body provides a grip for a user adjacent the post aperture for fitting the post aperture over the post. A distal depression located at the distal end of the main body provides a grip for a user when actuating the gas meter valve. A loop aperture located at the distal end of the main body attaches the tool to a user or near the gas meter valve.

### BRIEF DESCRIPTION OF THE DRAWINGS

FIG. 1 shows a side view of a gas meter valve for use with the present invention, where the gas meter valve is in an open position;

FIG. 2 shows a gas meter valve for use with the present invention where the gas meter valve is in a closed position;

FIG. 3 shows a perspective view of a gas meter valve tool of this invention;

FIG. 4 shows a bottom view of the gas meter valve tool of this invention; and

FIG. 5 shows a side view of the gas meter valve tool of this invention.

### DETAILED DESCRIPTION OF THE PREFERRED EMBODIMENT

With reference to the Figures, a one piece tool 20 is shown for use with a gas meter valve 10 having a movable core with an arm 16 extending outwardly therefrom. The arm 16 has a post 18 that extends upwardly from an outer end of arm 16. The tool 20 includes a main body 22 with a handle portion 23 located at a distal end of the main body 22. A post aperture 24 is located at a proximal end of the main body 22. The post aperture 24 is formed to receive post 18 and encircles the post 18 of the gas meter valve 10 to actuate the core 14 of the gas meter valve 10.

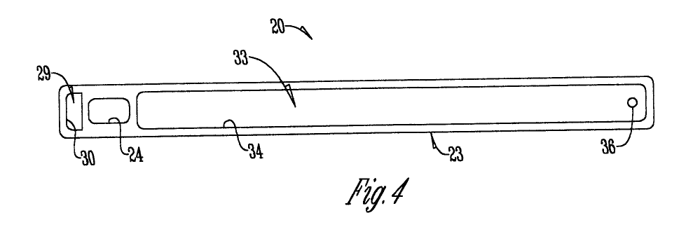

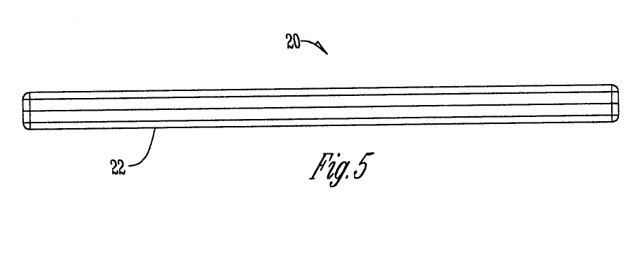

With reference to FIGS. 3 and 4, at the proximal end of the main body 22, proximal depression 28 on the top of the tool 20 and a proximal depression 30 on the bottom of the tool 20 creates a first grip area 29 for a user to grip the tool. Depressions 28 and 30 are adjacent the post aperture 24. The grip area 29 provides a user greater control over the tool 20 for fitting the post aperture 24 over the post 18.

At the distal end of the main body 22 is a distal depression 32 on the top of the tool 20 and a distal depression 34 on the bottom of the tool 20 that create a second grip area 33 which further assists the user in holding the tool 20 during operation.

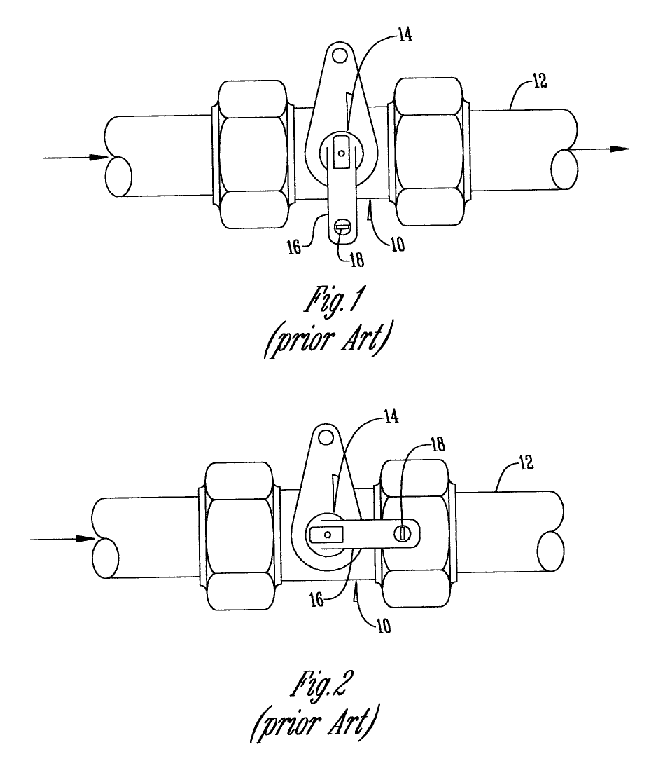

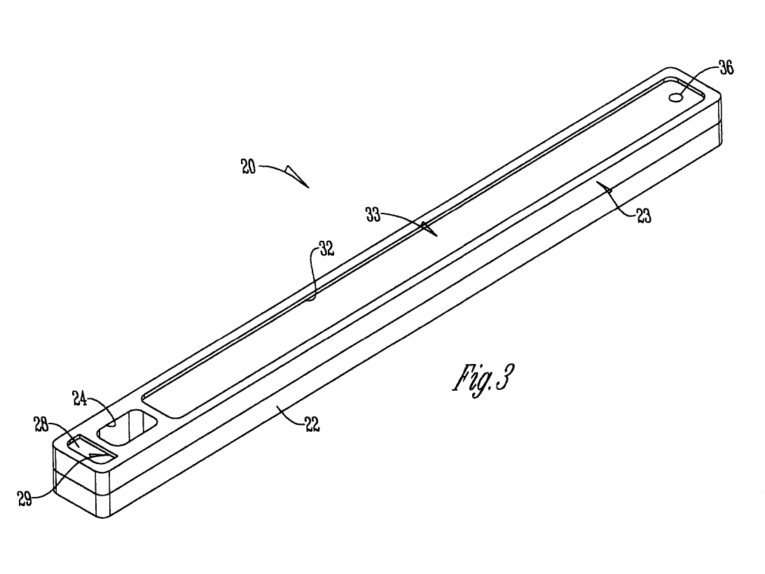

With reference back to FIGS. 1 and 3, an aperture 36 located at the distal end of the main body 22 is provided for attaching the tool 20 to a user (not shown) or near the gas meter valve 10 using a loop or similar structure. Such attachment may be by any means known in the art such as a string, wire, hooks, fasteners, key chains, retractable key chains fasteners, combinations thereof, or the like.

Additionally, the tool 20 may be colored to blend in with the gas meter, or alternatively given a bright color to indicate its emergency use (such as bright yellow, for example).

In operation, a user grips the one piece tool 20 by the first grip area 29 and the second grip area 33 of the handle portion 23 and fits the post aperture 24 around the post 18 of the gas meter valve 10.

Once the post aperture 24 is positioned around the post 18, the user exerts force on the handle portion 23 in a lateral direction. The one piece tool 20 transfers the rotational force from the user to the post 18 of the gas meter valve 10, moving the core 14 from the on position to the off position in a clockwise or counter clockwise direction moving the gas meter to either an “on” or “off” position.

Whereas the invention has been shown and described in connection with the embodiments thereof, it will be understood that many modifications, substitutions, and additions may be made which are within the intended broad scope of the following claims. From the foregoing, it can be seen that the present invention accomplishes at least all of the stated objectives.

1-9. (canceled)

10. A tool for use with a gas meter valve, wherein the gas meter valve has a movable core operatively connected to a post for actuation of the core, the tool comprising:
a main body having a handle portion located at a first end of the main body and a post aperture located at a second end of the main body;
the post aperture adapted to receive the post of the gas meter valve;
an aperture located at the first end of the main body, the aperture adapted to attach the tool to or near the gas meter valve;
a pair of first depressions located on the top and bottom of the first end of the main body, the first depressions adapted to provide a grip for a user; and
a pair of second depressions located on the top and bottom of the second end of the main body, the second depression adapted to provide a grip for a user adjacent the post aperture;
wherein the tool is of one piece construction; and
wherein the post aperture completely encloses the post of the gas meter valve.

11. The tool of claim 10, wherein the tool is colored to blend in with the gas meter.

12. The tool of claim 10, wherein the tool is colored a bright color to indicate its emergency use.

13. The tool of claim 10 wherein the main body is rectangular in shape.

14. The tool of claim 10 wherein the main body having edges that are parallel to one another.
